(19) United States
(12) Patent Application Publication
(10) Pub. No.: US 2012/0272239 A1
(43) Pub. Date: Oct. 25, 2012

(54) SHARING CLASS DATA

(75) Inventors: Prasanna K. Kalle, Bangalore (IN); Roopa K. Rao, Bangalore (IN); Andrew R. Low, Stittsville (CA); Aneesh K.K. Veetil, Bangalore (IN)

(73) Assignee: International Business Machines Corporation, Armonk, NY (US)

(21) Appl. No.: 13/093,420

(22) Filed: Apr. 25, 2011

(51) Int. Cl. G06F 9/455

(52) U.S. Cl. 718/1

(57) ABSTRACT

This docucment descirbes techniques for sharing Java class information in virtualized computing environments. In some embodimetns, an apparatus includes hardware components including one or more central processing units and main memory, wherein a portion of the main memory is configured to store shared Java classes. The apparatus can also include a hypervisor configured to control access to the hardware components, and to host a plurality of operating systems. Each of the operating systems can include a character device driver configured to write directly to the portion of main memory configured to store the shared Java classes. The apparatus can also include one or more Java virtual machines configured to execute the shared Java classes and modify the shared Java classes using the character device driver.

### BACKGROUND

The present invention relates to virtualized computers, and more particularly to sharing class data among virtual machine applications running on guests in a virtualized environment using a memory management facility.

Some computer systems can simultaneously execute multiple operating systems. In such computer systems, the operating systems share computer resources, so that one physical computer can act as many computers. In some instances, a main operating system allows multiple guest operating systems to share a computer's physical resources, such as disk, memory, network adapters, CPUs etc. The main operating system can includes a hypervisor, which manages such resource sharing.

In some instances, computer systems can derive efficiencies from sharing data between software running in different guest operating systems. For example, such data sharing can reduce the amount of memory needed for executing application programs in the different guest operating systems.

### BRIEF DESCRIPTION OF THE DRAWINGS

The present embodiments may be better understood, and numerous objects, features, and advantages made apparent to those skilled in the art by referencing the accompanying drawings.

FIG. 1 is a block diagram illustrating a computer system capable of hosting multiple operating systems, according to some embodiments of the invention.

FIG. 2 is a block diagram showing Java virtual machines sharing class files, according to some embodiments of the invention.

FIG. 3 is a block diagram illustrating operations for modifying information in a shared class cache, according to some embodiments of the invention.

FIG. 4 is a flow diagram illustrating operations for preparing a dis-continuous shared segment for sharing Java classes, according to some embodiments of the invention.

FIG. 5 is a flow diagram illustrating operations for accessing shared Java code, according to some embodiments of the invention.

### SUMMARY

In some embodiments, an apparatus includes hardware components including one or more central processing units and main memory, wherein a portion of the main memory is configured to store shared Java classes. The apparatus can also include a hypervisor configured to control access to the hardware components, and to host a plurality of operating systems. Each of the operating systems can include a character device driver configured to write directly to the portion of main memory configured to store the shared Java classes. The apparatus can also include one or more Java virtual machines configured to execute the shared Java classes and modify the shared Java classes using the character device driver.

Some embodiments also include a method for sharing Java classes in a computer system. Such a method can include loading program code and data into a shared memory, where the program code and includes Java classes, and wherein the shared memory is shared by a plurality of Java virtual machines (JVMs) each executing in a different operating system of the computer system. The method can also include modifying the program code and data in the shared memory, wherein the modifying is performed, at least in part, by a character device driver that directly writes to the shared memory. The method can also include executing, by one or more of the Java Virtual Machines, the program code in the shared memory.

### DESCRIPTION OF EMBODIMENT(S)

The description that follows includes exemplary systems, methods, techniques, instruction sequences and computer program products that embody techniques of the present inventive subject matter. However, it is understood that the described embodiments may be practiced without these specific details. For instance, although examples refer to Java® virtual machines, some embodiments work with other virtual machines. In some instances, well-known instruction instances, protocols, structures and techniques have not been shown to avoid obfuscating the description.

Some computers can host multiple operating systems. For example, a computer may simultaneously host a version of IBM's AIX operating system, and a version of the Linux operating system. Typically, a computer that hosts multiple operating systems includes a hypervisor that enables each operating system to utilize the computers' resources. In some instances, a hypervisor is a software layer between the computer's hardware and the operating systems. Thus, each operating system can interact with the hypervisor as if the operating system was interacting with computer hardware.

While the hypervisor can host multiple operating systems, each of the operating systems can host one or more Java virtual machines (JVMs). In some instances, all the JVMs may require the same classes (e.g., Java program code and data) for executing Java application programs. Instead of creating duplicates of the Java classes, some embodiments of the inventive subject matter enable the JVMs to share a single instance of the classes. These embodiments facilitate class sharing where the JVMs are operating in multiple operating systems, and where the operating systems are executing on a hypervisor.

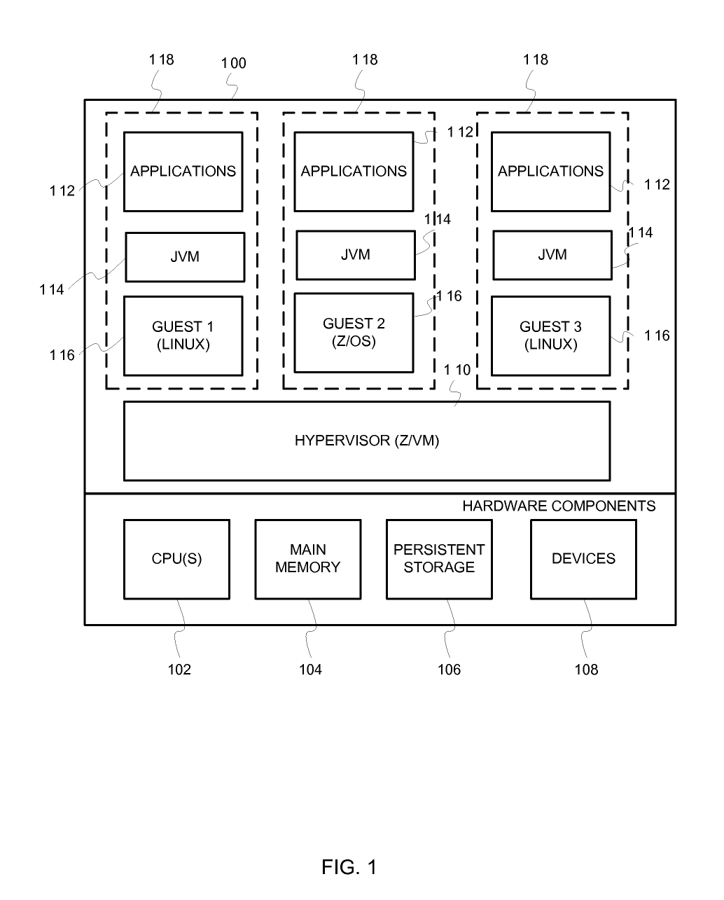

FIG. 1 is a block diagram illustrating a computer system capable of hosting multiple operating systems, according to some embodiments of the invention. FIG. 1 shows a computer 100, which includes hardware components including CPU(s) 102, main memory 104, persistent storage 106, and devices 108. The computer 100 also includes a hypervisor 110 that can create a plurality of environments 118 on the computer 100. That is, the hypervisor can host multiple operating systems, where the operating systems run independently and contemporaneously. In some embodiments, the hypervisor 110 is part of a z/VM® Operating System (available from IBM® Corporation). In FIG. 1, the hypervisor 110 is hosting three guest operating systems 116 including two Linux® operating systems, and a z/OS® operating system. The hypervisor 110 enables each guest operating system 116 to operate as if the guest operating system itself were utilizing and managing the computer's hardware components. That is, each guest operating system 116 executes as if there were no hypervisor 110 and no other operating systems on the computer 100.

In FIG. 1, each guest operating system 116 hosts a Java virtual machine (JVM) 114. Each JVM 114 executes application programs 112 in their respective environments 118. In some instances, each guest operating system 116 can host any number of JVMs 114.

Although FIG. 1 shows many components, the computer 100 can include any other suitable components, such as buses, controllers, peripheral devices, etc. Furthermore, FIG. 1 is an abstract representation, showing the components in a layered fashion. The layering shows how the components interact with each other. For example, the hypervisor 110 manages access to the hardware components. Thus, if the guest operating systems 116 want to utilize the hardware components (e.g., as part of a process for executing an application program 112), they submit requests to the hypervisor 110. Similarly, at higher layers, the JVMs 114 request resources from guest operating systems 116, and so on.

The application programs 112 include Java program code, which includes Java byte codes. Java is an objected-oriented programing language that organizes code into Java class files. Thus, the Java program code can also include data. A JVM 114 executes an application program 112 by processing the Java program code. The Java program code may call other Java code included in the class files. In turn, the JVM 114 fetches and executes the Java class files (e.g., from persistent storage 106).

In some instances, JVMs in different environments 118 need the same class files. For example, JVMs 114 in the Linux and z/OS environments may need a particular class file. There may be two identical copies of the class file residing in the Linux and z/OS environments. Alternatively, there is a single copy of the needed class file residing on a file system shared by the Linux and z/OS environments. Instead of loading multiple copies of the needed class files into the main memory 104, some embodiments facilitate Java class sharing between JVMs in different environments 118. For example, some embodiments enable the JVMs operating in the Linux and z/OS environments to share Java classes, avoiding duplicate instances of the shared Java class code in main memory 104. By eliminating duplicate instances of shared java class code, embodiments of the invention enable more of the computer's resources to be available for other purposes, such as for additional environments, JVMs, applications, etc.

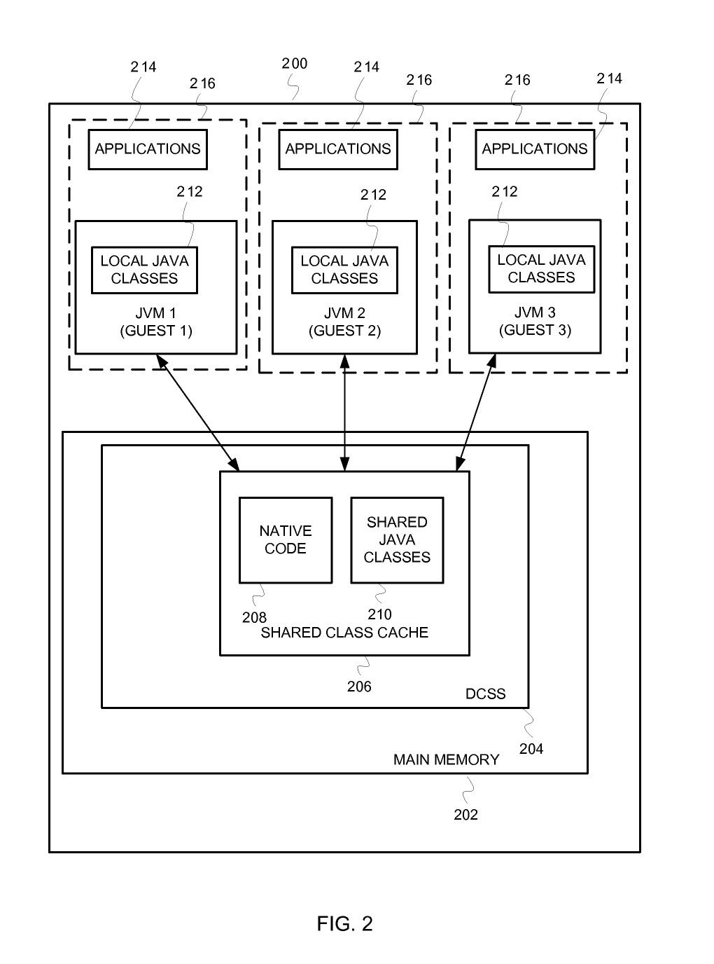

FIG. 2 is a block diagram showing Java virtual machines sharing class files, according to some embodiments of the invention. In FIG. 2, a computer 200 includes a main memory 202, which includes a dis-continuous saved segment (DCSS) 204. A hypervisor (not shown in FIG. 2) defines the DCSS 204 as a range of addresses in the main memory 202. The DCSS 204 includes a shared class cache 206, which includes shared Java classes 210 and native code 208. The hypervisor sets-up the DCSS 204 to facilitate data sharing between environments, as will be described below.

The computer 200 also includes JVM 1, JVM 2, and JVM 3. Each of the JVMs includes local Java classes 212. In FIG. 2, each JVM is part of a separate environment 216. For example, JVM 1 may be executing in a Linux environment, while JVM 2 executes in a z/OS environment, as similarly shown in FIG. 1. As the JVMs execute application programs 214, they load Java classes. Some application programs 214 require Java classes that are not needed by other application programs. Thus, JVMs load these Java classes into their respective environments (shown as local java classes 212). However, in some instances, multiple application programs 214 require the same Java classes. For example, applications running on JVM 1 may require the same Java classes as applications running on JVM 2. To avoid loading multiple copies of the required Java classes into the main memory 202, the JVMs create the shared class cache 206 inside the DCSS 204. Because the shared class cache 206 resides in the DCSS 204, the hypervisor facilitates creation and storage of classes. As the JVMs need Java classes, they determine whether those classes reside in the shared class cache (SCC) 206. If the classes reside in the SCC 206, the JVMs can execute them from the SSC 206. That is, the JVMs need not make additional copies to interpret the shared Java classes 210. Embodiments can use any suitable technique for loading classes into the SCC 206.

In the past, some multi-environment operating systems supported DCSSs for sharing data between environments. However, DCSSs were not suitable for sharing Java classes because the DCSSs were not immediately updated after write operations. That is, if a JVM updated the shared class cache, the updates would not appear in the cache until after some delay. Such write delays would cause coherency issues if multiple JVMs attempted to update the shared class cache. Embodiments of the inventive subject matter facilitate direct and immediate write operations to data in the DCSS. Therefore, embodiments of the invention enable JVMs to share java classes in the DCSS, and thus across multiple guest operating systems.

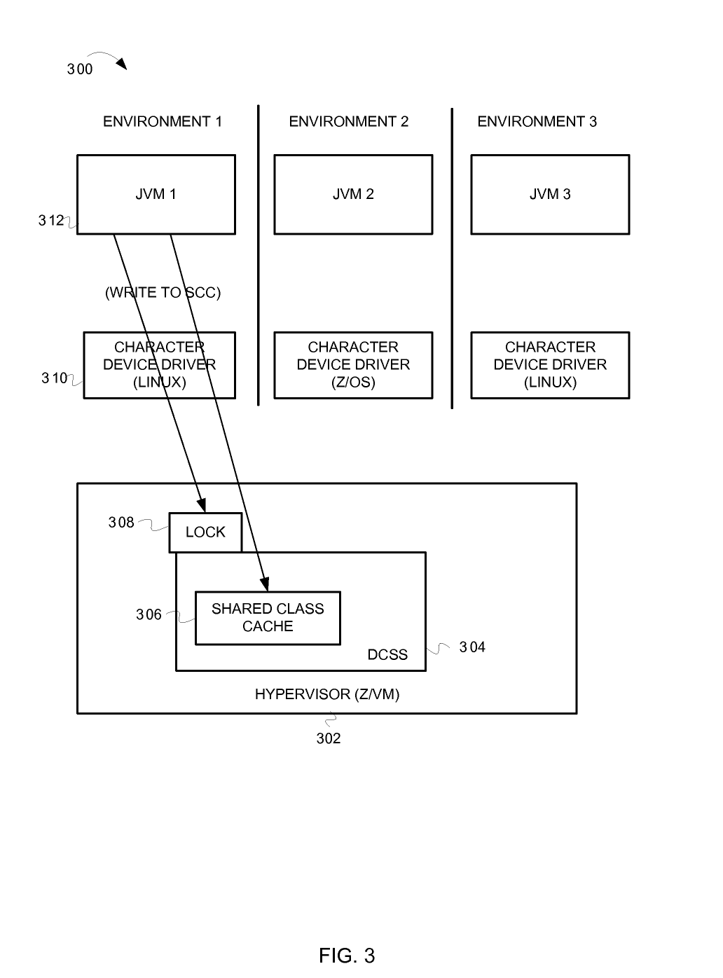

FIG. 3 is a block diagram showing how embodiments can modify information in a shared class cache. In FIG. 3, a computer 300 includes a hypervisor 302 that configures and controls a DCSS 304. As noted above, the DCSS 304 is a portion of main memory that has been reserved for sharing data between environments. The DCSS 304 includes an SCC 306, which includes Java classes and native code in a form executable by a processor. A lock 308 is used to ensure that write operations to the SCC 306 are atomic. That is, the lock ensures that only one JVM can modify the SCC 306 at any given time.

In FIG. 3, the hypervisor 302 supports three environments: two Linux environments and a z/OS environment. Each environment includes a JVM 312 and a character device driver 310. Although not shown, each character device driver 310 is part of an operating system that runs the environment.

FIG. 3 shows operations for modifying information in the SCC 306. At some point during operation, the JVM 1 determines that it will modify classes in the SCC 306. Before the JVM 1 writes to the SCC 306, the JVM 1 attempts to acquire the lock 308. If the lock is available, the JVM 1 can write to the SCC 306. If not, the JVM 1 must wait until it can acquire the lock. After acquiring the lock, the JVM 1 uses the character device driver 310 to write Java class information to the SCC 306. The character device driver 310 directly modifies (i.e. writes) shared java class data without delays. That is, any modifications to the SCC 306 are immediately available to all the JVMs in the computer 300. Thus, immediately after JVM 1 modifies the SCC 306, the JVM 2 can immediately read the updated Java class data. Because the character device drivers 310 write data directly to devices without delays, such as queuing, caching, buffering, etc., the JVMs can share data across guest operating systems.

The following discussion provides more details about how some embodiments share Java classes across multiple operating systems.

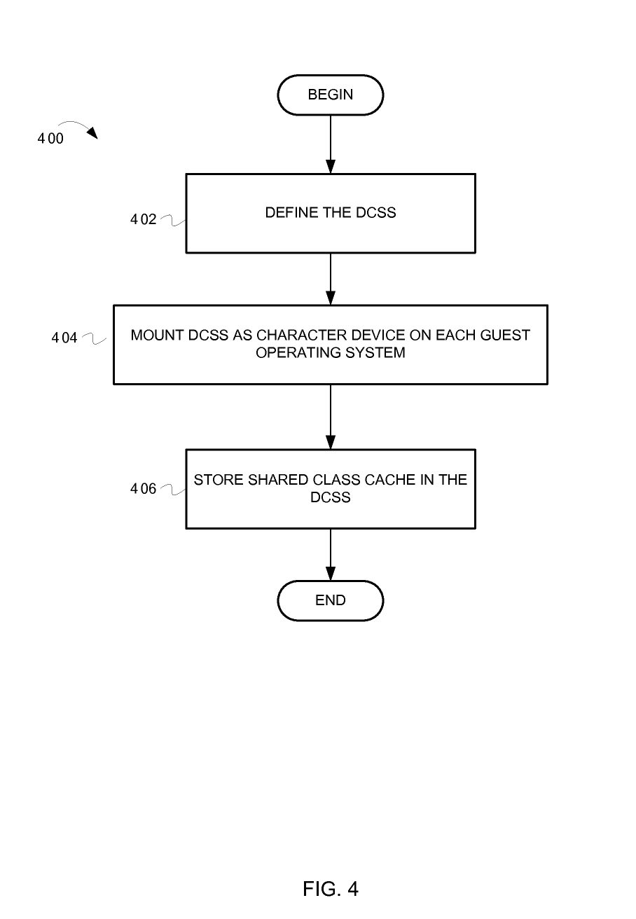

FIG. 4 is a flow diagram illustrating operations for preparing a dis-continuous shared segment for sharing Java classes, according to some embodiments of the invention. The operations in FIG. 4 are described with respect to the components shown in FIG. 2.

In FIG. 4, the flow 400 begins at block 402. At block 402, a hypervisor configures the DCSS 204. For example, the hypervisor selects an address range for the DCSS 204 in the main memory 202. In some embodiments, the hypervisor configures the DCSS 204 based on user input. For example, a system administrator selects the address range for the DCSS 204. The flow continues at block 404. At block 404, each operating system in the environments 216 defines the DCSS 204 as a character device. In some instances, the operating systems (e.g., Linux, z/OS, etc.) provides character device drivers that can be configured to access the DCSS. As a result, each operating system can access the DCSS 204 using a character device driver. The flow continues at block 406. At block 406, the JVM, with assistance from the hypervisor, creates a shared class cache 206 in the DCSS 204. The shared class cache 206 includes Java classes that are shared by two or more of the JVMs. From block 406, the flow ends.

After executing the operations in FIG. 4, a computer has configured a mechanism for sharing Java classes across guest operating systems in a computer. The discussion continues with more details about how JVMs can access the shared Java classes.

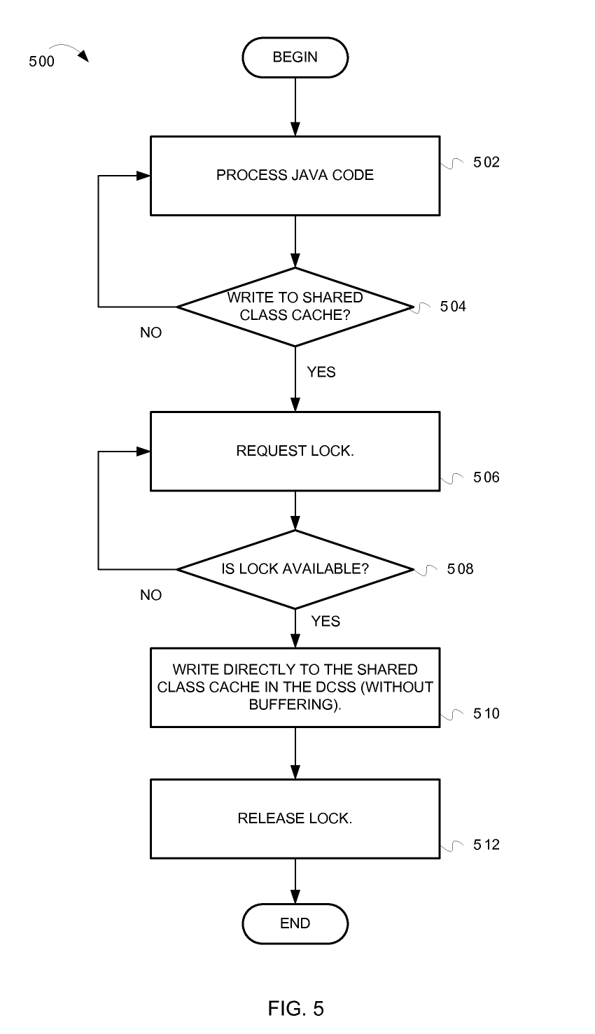

FIG. 5 is a flow diagram illustrating operations for updating shared Java classes, according to some embodiments of the invention. In FIG. 5, a flow 500 begins at block 502. At block 502, a JVM processes Java code. For example, a JVM begins processing an application's Java code. The flow continues at block 504.

After processing Java code, the JVM determines whether it needs to update one or more shared Java classes, at block 504. If the JVM needs to update shared Java classes, the flow continues at block 506. Otherwise, the flow loops back to block 502. In some embodiments, shared Java classes are stored in a DCSS. As described vis-à-vis FIG. 4, the DCSS can be defined as a character device available to the JVM. The JVM uses a character device driver to modify shared Java classes stored in the DCSS.

At block 506, the JVM requests a lock that protects the shared Java classes. If the lock is available (block 508), the JVM uses a character device driver to write directly to the DCSS, modifying the shared Java classes (block 510). If the lock is not available, the flow loops back to block 506 and requests the lock again. After writing to the shared Java classes in the DCSS, the JVM releases the lock (block 512). After releasing the lock, the flow ends.

As will be appreciated by one skilled in the art, aspects of the present inventive subject matter may be embodied as a system, method or computer program product. Accordingly, aspects of the present inventive subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present inventive subject matter may be written in any combination of one or more programming languages, including an object oriented programming language such as Java, Smalltalk, etc. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Referring back to FIG. 1, although the computer 100 includes CPU(s) 102, it can include multiple processors, multiple cores, multiple nodes, and/or it can implement multi-threading, etc. The main memory 104 may include one or more of cache, SRAM, DRAM, zero capacitor RAM, Twin Transistor RAM, eDRAM, EDO RAM, DDR RAM, EEPROM, NRAM, RRAM, SONOS, PRAM, etc. Additionally, the main memory 104 can include one or more of the above already described possible realizations of machine-readable media. The computer system also includes one or more buses (e.g., PCI, ISA, PCI-Express, HyperTransport®, InfiniBand®, NuBus, etc.), network interfaces (e.g., an ATM interface, an Ethernet interface, a Frame Relay interface, SONET interface, wireless interface, etc.). The persistent storage 106 can include optical storage, magnetic storage, etc. In some embodiments, the main memory 104 includes functionality to implement embodiments described above. For example, the main memory 104 can include the OSs 116, the JVMs 114, the character device drivers (not shown in FIG. 1), etc. Any one of these functionalities may be partially (or entirely) implemented in hardware and/or on the CPU(s) 102. For example, the functionality may be implemented with an application specific integrated circuit, in logic implemented in the CPU(s) 102, in a co-processor on a peripheral device or card, etc. Further, realizations may include fewer or additional components not illustrated in the Figures.

While the embodiments are described with reference to various implementations and exploitations, it will be understood that these embodiments are illustrative and that the scope of the inventive subject matter is not limited to them. In general, techniques sharing Java classes between JVMs in a multi-OS environment, as described herein, may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. An apparatus comprising:
hardware components including one or more central processing units and main memory, wherein a portion of the main memory is configured to store shared Java classes;
a hypervisor configured to control access to the hardware components, and to host a plurality of operating systems, wherein each of the operating systems includes,
a character device driver configured to write directly to the portion of main memory configured to store the shared Java classes;
one or more Java virtual machines configured to
execute the shared Java classes; and
modify the shared Java classes using the character device driver.

2. The apparatus of claim 1, wherein the portion of main memory is configured as a character device in each of the operating systems.

3. The apparatus of claim 1, wherein the hypervisor includes a lock configured to control access to the portion of the memory configured to store the Java classes.

4. The apparatus of claim 1, wherein the portion of main memory further includes program code that is native to the central processing units, and wherein the Java virtual machines are further configured to cause the native code to execute on the central processing units.

5. The apparatus of claim 1, wherein hypervisor is part of a z/VM operating system, and wherein the portion of memory is configured to operate as a dis-continuous shared segment.

6. A method for sharing Java classes in a computer system, the method comprising:
loading program code into a shared memory, where the program code includes Java classes, and wherein the shared memory is shared by a plurality of Java Virtual Machines (JVMs) each executing in a different operating system of the computer system;
modifying the program code in the shared memory, wherein the modifying is performed, at least in part, by a character device driver that directly writes to the shared memory; and
executing, by one or more of the Java Virtual Machines, the program code in the shared memory.

7. The method of claim 6 further comprising:
configuring the shared memory as a character device in each of the different operating systems of the computer system, wherein the character device is accessible by the character device driver, and other character device drivers.

8. The method of claim 6, wherein the shared memory is a dis-continuous shared segment defined by a hypervisor residing in the computer system.

9. The method of claim 6 further comprising:
requesting access to a lock that excludes access to the shared memory, wherein the requesting occurs before the modifying;
receiving access to the lock;

10. The method of claim 6, wherein the computer system includes a main memory, and wherein the shared memory occupies a portion of the main memory.

11. The method of claim 6, wherein the program code also includes machine code native to the computer system.

12. One or more computer readable storage media having stored therein a program product, which when executed a set of one or more processor units causes the set of one or more processor units to perform operations for sharing Java classes in a computer system, the operations comprising:
loading program code into a shared memory, where the program code includes Java classes, and wherein the shared memory is shared by a plurality of Java Virtual Machines (JVMs) each executing in a different operating system of the computer system;
modifying the program code in the shared memory, wherein the modifying is performed, at least in part, by a character device driver that directly writes to the shared memory; and
executing, by one or more of the Java Virtual Machines, the program code in the shared memory.

13. The one or more computer readable storage media of claim 12, wherein the operations further comprise:
configuring the shared memory as a character device in each of the different operating systems of the computer system, wherein the character device is accessible by the character device driver, and other character device drivers.

14. The one or more computer readable storage media of claim 12, wherein the shared memory is a dis-continuous shared segment defined by a hypervisor residing in the computer system.

15. The one or more computer readable storage media of claim 12, wherein the operations further comprise:
requesting access to a lock that excludes access to the shared memory, wherein the requesting occurs before the modifying;
receiving access to the lock;

16. The one or more computer readable storage media of claim 12, wherein the computer system includes a main memory, and wherein the shared memory occupies a portion of the main memory.

17. The one or more computer readable storage media of claim 12, wherein the program code also includes machine code native to the computer system.
